(19) United States
(12) Patent Application Publication
(10) Pub. No.: US 2020/0123720 A1
(43) Pub. Date: Apr. 23, 2020

(54) Landslide protection device

(71) Applicant: Yesha Zahng, Lishui City (CN)

(72) Inventor: Yesha Zahng, Lishui City (CN)

(21) Appl. No.: 16/719,908

(22) Filed: Dec. 18, 2019

(51) Int. Cl. E01F 7/04; E01H 1/00; F16H 7/02; F16H 7/06

(52) U.S. Cl. CPC E01F 7/045; F16H 7/06; F16H 7/02; E01H 1/00

(57) ABSTRACT

A landslide protection device disclosed by the present invention includes a mountain body and a roadbed. The roadbed is fixedly disposed at the upper end of the mountain body. Cavities are formed in the roadbed to penetrate left and right. Rolling stones can roll down the mountain through the cavity to prevent rolling stones from falling on the upper end surface of the roadbed to block traffic. The cavity is provided with a buffer device. The present invention is arranged in the roadbed in the area where the frequency of landslides is high. It can avoid traffic congestion caused by falling rocks directly on the road. Because the mountain has a certain slope, the speed of the rolling rocks is faster. When the rocks are cleared, the rolling speed is slowed down and the device is restored to the initial state after the landslides And can automatically clear the rolling stones that fell on the road.

### CROSS-REFERENCES TO RELATED APPLICATIONS

The present application claims priority from Chinese application No. 2019106784299 filed on Jul. 25, 2019 which is hereby incorporated by reference in its entirety.

### TECHNICAL FIELD

The invention relates to the field of natural disaster protection, in particular to a landslide protection device.

### BACKGROUND OF THE INVENTION

A landslide refers to a part of the rock and soil on the slope of the mountain that moves under the slope as a whole under the influence of gravity (including the gravity of the rock and soil and the dynamic and static pressure of groundwater) and moves downward along the slope. Functions and phenomena, commonly known as “walking the mountain”, “collapsed mountain”, “ground slip”, “soil slip”, etc., is one of the common geological disasters. After landslides, a lot of rolling stones often fall on the road beside the mountain. It causes traffic jams and affects the driving of rescue vehicles, causing a lot of economic losses and casualties. A landslide protection device described in the present invention can solve the above problems. The present invention is arranged in a roadbed in a region where the landslide frequency is high. After the landslide occurs, the rolling stones can be dredged and guided. It can also avoid the traffic jam caused by the rolling stones falling directly on the road. Because the mountain has a certain slope, the rolling stones roll faster, and the rolling stones are slowed down when they are cleared. After the landslide is over, the device will be restored to the initial state and the rolling stones falling on the pavement will be cleaned up automatically.

### BRIEF SUMMARY OF THE INVENTION

### Technical Problem

After a landslide, it often causes traffic jams and affects the driving of rescue vehicles, causing a lot of economic losses and casualties.

In order to solve the above problems, a landslide protection device is designed in this example. A landslide protection device in this example includes a mountain body and a roadbed. The roadbed is fixedly disposed at the upper end of the mountain body. There is a cavity, and the rolling stone can be rolled down to the mountain through the cavity to prevent the rolling stone from falling on the upper end surface of the roadbed to block the traffic. The cavity is provided with a buffer device. The buffer device can buffer the rolling stones. A driving device is provided in the upper inner wall of the cavity, and a protective device is provided on the left side of the driving device. The protective device can prevent a large number of rolling stones from falling on the roadbed. A cleaning device is provided on the right side of the driving device, and the cleaning device can centrally process the rolling stones on the roadbed. The protective device, the driving device, and the cleaning device are connected by a chain, and the driving device passes The chain can drive the protective device and the cleaning device at the same time, and two transmission belts are connected between the protective device and the driving device. Two transmission belts can drive the protective device, and a protective plate is fixedly connected to the upper end of the roadbed, and the protective plate is located at the far right of the upper end of the roadbed, and can provide protection for vehicles traveling on the roadbed. Six support columns are fixedly connected between the inner wall of the upper side of the cavity and the mountain body, and the support columns can support the roadbed.

Beneficially, the driving device includes a belt groove symmetrically provided in the inner wall on the upper side of the cavity, and a driving pulley is rotatably provided in the belt groove, and the lower ends of the two transmission belts are respectively connected to the belt grooves. A driving pulley, an upper end of the transmission belt is connected to the cleaning device, a motor shaft is fixedly connected between the driving pulleys on both sides, and a motor is fixed in the front inner wall of the belt groove on the front side, and the motor The front end of the shaft is dynamically connected to the motor, and a chain groove is provided between the belt grooves on both sides. An active sprocket is rotatably provided in the chain groove, and the active sprocket is fixedly connected to the motor shaft. The chain is connected to the active sprocket, the left end of the chain is connected to the protection device, the right end of the chain is connected to the cleaning device, the motor is started, and the active sprocket is driven to rotate by the motor shaft Then, the protection device and the cleaning device are simultaneously driven by the chain, and the driving shaft is driven to rotate by the motor shaft, and then the protection device is driven by the transmission belt.

Advantageously, the protective device comprises a sprocket cavity connected to an inner wall of the left side of the chain groove, the sprocket cavity is opened to the left, and the left sprocket is rotatably provided in the sprocket cavity. The left end of the chain is connected to the left sprocket, and the left sprocket is internally connected with a connecting shaft. The front and back ends of the connecting shaft are rotatably connected to the inner walls of the front and back sides of the sprocket cavity. A connecting gear is symmetrical and rotatable on both sides, the connecting gear is fixedly connected to the connecting shaft, a baffle is slidably provided on the left side of the roadbed, and the right end of the baffle abuts the roadbed. The baffle can only slide up and down. The left and right through the baffle are provided with four through grooves with downward openings. Small rolling stones can pass through the through grooves to prevent small rolling stones from accumulating on the left side of the roadbed. Two right racks are fixed symmetrically in the right end face. The left ends of the two connecting gears are respectively engaged with the two racks. The active sprocket rotates to drive the left sprocket to rotate through the chain. Further, the connecting gear is driven to rotate by the connecting shaft, thereby further driving the Article increased and the baffle.

Beneficially, a groove is provided in the upper inner wall of the upper side of the chain groove, the opening is upward and the opening is leftward, and a push plate is symmetrically and slidably provided in the groove, and the push plates on both sides are slidable. A toothed slider is provided, and the toothed slider can be engaged with the push plates on both sides by toothing. The toothed slider is provided with a right hinged cavity opening to the left through the upper and lower sides. A right hinge shaft is rotatably connected between the front and rear inner walls of the right hinge cavity, and a connecting rod is fixedly connected on the peripheral surface of the right hinge shaft. A left hinge cavity with an upward opening and a left hinge cavity are penetrated through the baffle. A left hinge shaft is rotatably connected between the front and rear inner walls, and the left end of the link is fixedly connected to the left hinge shaft. The push plate is provided with a threaded hole whose opening faces away from the center of symmetry, and a screw is screwed inside the threaded hole. The belt grooves on both sides are respectively located in the inner walls of the front and rear sides of the groove, and a driven pulley is rotatably provided in the belt groove. The upper end of the transmission belt is connected to the driven pulley, and the screw The end far from the center of symmetry is respectively fixed to the driven pulley, and the driving belt Rotate and drive the driven pulley through the transmission belt, and then drive the push plates on both sides to slide close to each other by the screw, while the baffle slides up, and then drive the left through the left hinge shaft The connecting rod swings, thereby driving the toothed slider to slide through the right hinge shaft, so that the toothed slider and the push plate are always maintained in meshing state, and the toothed slider is engaged with the push plate When the toothed slider cannot slide to the left, and then the baffle is supported by the link, the push plate is provided with a spring slot with an opening facing the center of symmetry. A support plate is slidingly provided, and springs are fixedly connected between the front and rear ends of the support plate and the inner wall of the spring groove side away from the symmetrical center.

Advantageously, the cleaning device includes a right sprocket that is rotatably provided on the right side of the active sprocket, the right end of the chain is connected to the right sprocket, and a short shaft is fixedly connected to the right sprocket. A driving gear is rotatably provided on the rear side of the right sprocket, the driving gear is fixedly connected to the short shaft, and a driven gear is provided on the upper end of the driving gear, and a vertical gear is fixed on the upper end of the driven gear. A straight shaft, a gear cavity is provided in the upper inner wall of the chain groove, and a large gear is rotatably provided in the gear cavity. The large gear is provided with a gear groove opening downward, and an upper end of the vertical shaft extends. A pinion gear is fixedly connected to the gear groove, and a transmission gear is provided at the left end of the pinion gear, the left end of the transmission gear is engaged with the large gear, and a slow shaft is fixedly connected to the upper end of the large gear. An upper end of the slow shaft extends to the outside of the roadbed and a cleaning plate is fixedly connected, the driving sprocket rotates and drives the right sprocket through the chain, and further drives the driving gear through the short shaft Rotation, which in turn drives the driven gear to rotate, and further passes the A straight shaft drives the small gear to rotate, which in turn drives the transmission gear to rotate, and then drives the large gear to rotate, and then drives the cleaning plate to rotate through the slow shaft, thereby concentrating the rolling stones on the roadbed to Together, the cleaning plate has a rotation range of 0 to 90°.

Advantageously, the buffer device includes six fixing blocks fixedly connected to the inner wall on the upper side of the cavity, and a torsion shaft is rotatably connected between the two front and rear fixing blocks, and the torsion shaft is fixedly connected on its peripheral surface. Buffer plate, torsion springs are fixedly connected between the front and back ends of the buffer plate and the fixed blocks on the front and back sides respectively, and the rolling plate can be cushioned by the buffer plate under the elastic force of the torsion spring.

The beneficial effect of the present invention is that the present invention is arranged in the roadbed in a region where the frequency of landslides is high. After the landslide occurs, the rolling stones can be dredged and guided, and it can also avoid the traffic congestion caused by the rolling stones and the like falling directly on the road. Slope. The speed of the rolling stones is relatively fast. When the rolling stones are dredged, the rolling speed is slowed down. After the landslide ends, the device is restored to the initial state and the rolling stones falling on the road surface can be automatically cleaned.

### BRIEF DESCRIPTION OF THE DRAWINGS

For ease of description, the present invention is described in detail by the following specific embodiments and the accompanying drawings.

FIG. 1 is a schematic diagram of the overall structure of a landslide protection device according to the present invention;

FIG. 2 is an enlarged schematic view of “A” of FIG. 1; FIG.

FIG. 3 is an enlarged schematic view of “B” of FIG. 1; FIG.

FIG. 4 is a schematic structural view in a direction “C-C” of FIG. 2; FIG.

FIG. 5 is a schematic structural diagram of a “D-D” direction of FIG. 2; FIG.

FIG. 6 is a schematic structural diagram of the “E-E” direction of FIG. 2; FIG.

FIG. 7 is a schematic structural diagram of the “F-F” direction of FIG. 2; FIG.

FIG. 8 is a schematic structural diagram of the “G-G” direction of FIG. 2; FIG.

FIG. 9 is a schematic structural diagram of the “H-H” direction of FIG. 3; FIG.

FIG. 10 is a schematic structural diagram of the “I-I” direction of FIG. 3

### DETAILED DESCRIPTION OF THE INVENTION

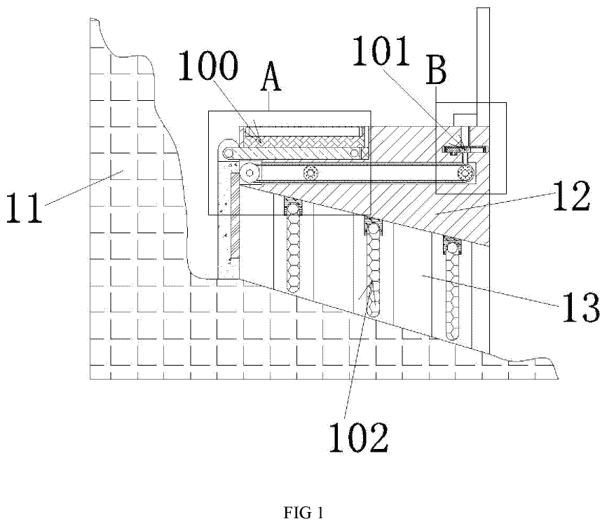

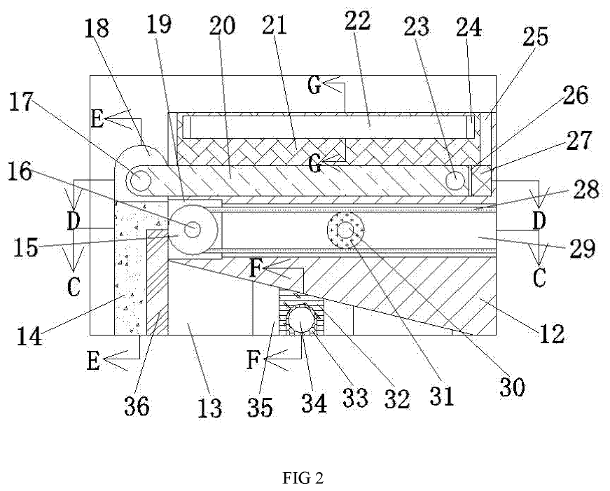

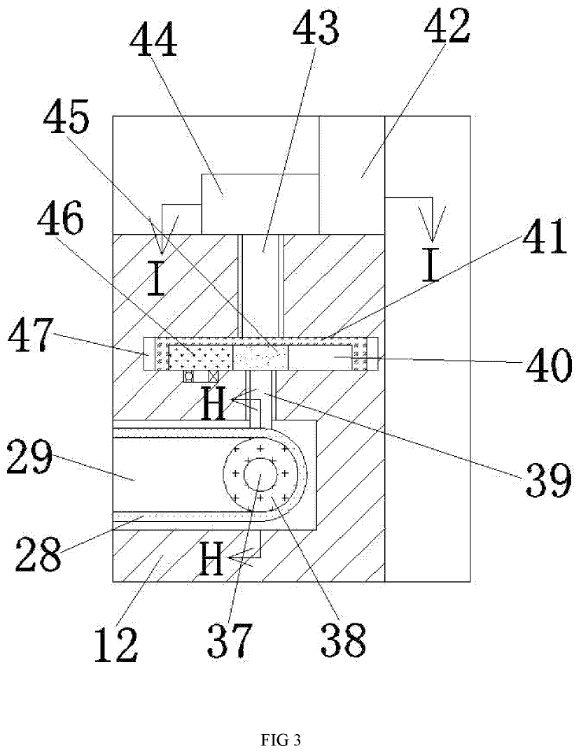

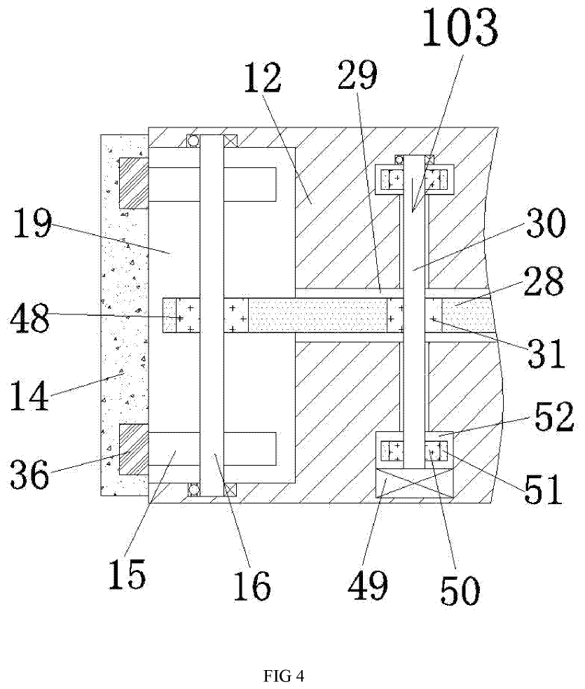

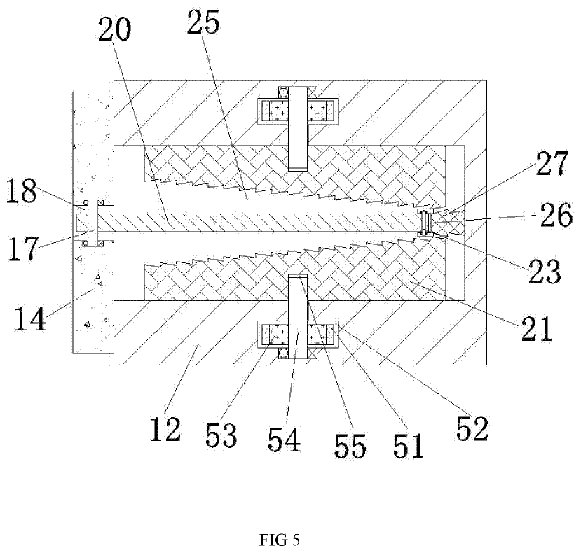

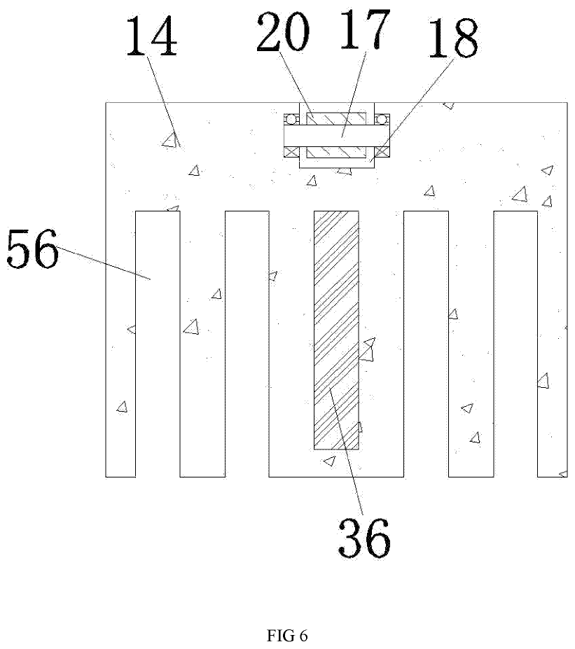

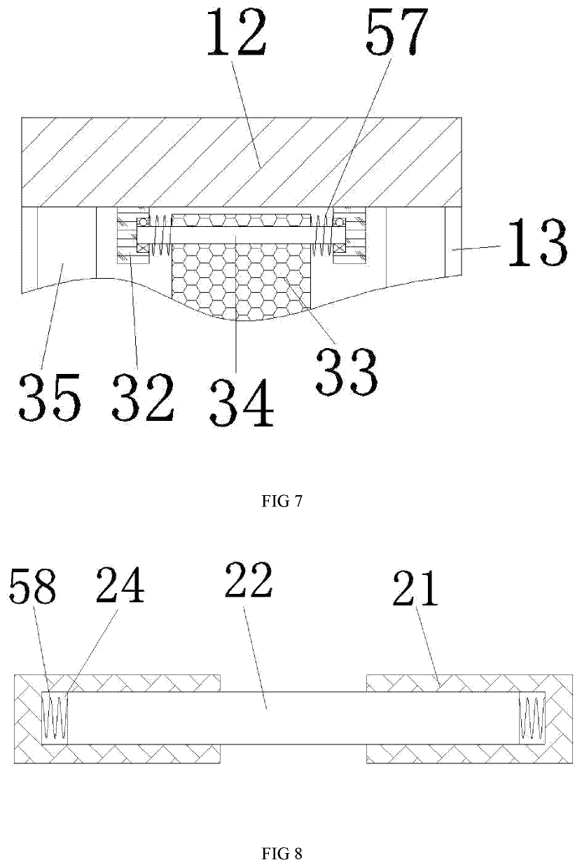

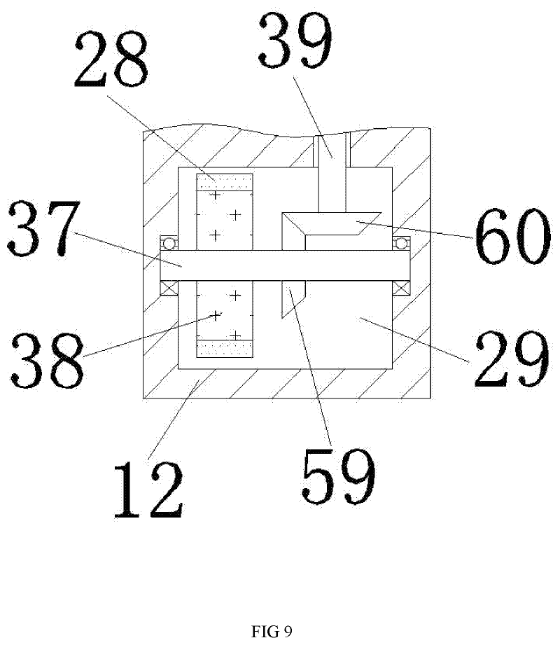

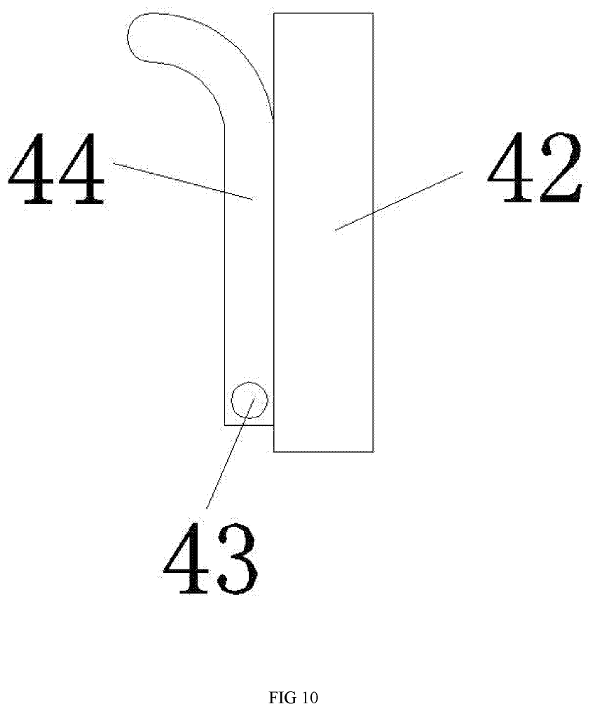

The present invention will be described in detail below with reference to FIGS. 1 to 10. For convenience of description, the orientation described below is defined as follows: the up-down, left-right, front-back direction described below is consistent with the up-down, left-right, front-back direction of the projection relationship of FIG. 1 itself

The invention relates to a landslide protection device, which is mainly used for dredging and protecting roads during landslides. The invention will be further described below with reference to the accompanying drawings of the invention:

A landslide protection device according to the present invention includes a mountain body 11 and a roadbed 12. The roadbed 12 is fixedly disposed on the upper end of the mountain body 11. Cavities 13 are formed in the roadbed 12 to penetrate left and right. The cavity 13 rolls down the mountain to prevent rolling stones from falling on the upper end surface of the roadbed 12 to block traffic. The cavity 13 is provided with a buffer device 102. Since the speed of the rolling stone is relatively high, the buffer device 102 passes through the buffer device 102. The rock can be buffered. A driving device 103 is provided in the inner wall on the upper side of the cavity 13, and a protective device 100 is provided on the left side of the driving device 103. The protective device 100 can prevent a large number of rolling stones from falling on the roadbed 12. On the right side of the driving device 103, a cleaning device 101 is provided. The cleaning device 101 can collectively process the rolling stones on the roadbed 12. Among the protective device 100, the driving device 103, and the cleaning device 101. They are connected by a chain 28, and the driving device 103 can simultaneously drive the protective device 100 and the cleaning device 101 through the chain 28. Two transmission belts 51 are connected between the protective device 100 and the driving device 103. So The driving device 103 can drive the protective device 100 through two transmission belts 51. A protective plate 42 is fixedly connected to the upper end of the roadbed 12, and the protective plate 42 is located at the far right of the upper end of the roadbed 12. Vehicles running on the subgrade 12 provide protection. Six support pillars 35 are fixedly connected between the inner wall of the upper side of the cavity 13 and the mountain 11, and the support pillars 35 can support the subgrade 12.

According to the embodiment, the driving device 103 will be described in detail below. The driving device 103 includes a belt groove 52 symmetrically provided in the inner wall on the upper side of the cavity 13. There are active pulleys 50, the lower ends of the two transmission belts 51 are connected to the active pulleys 50 respectively, the upper ends of the transmission belts 51 are connected to the cleaning device 101, and the active pulleys 50 on both sides are fixedly connected The motor shaft 30 has a motor 49 fixed in the front inner wall of the belt groove 52 on the front side, and the front end of the motor shaft 30 is dynamically connected to the motor 49. A chain groove is provided between the belt grooves 52 on both sides. 29. A driving sprocket 31 is rotatably provided in the chain groove 29, the driving sprocket 31 is fixedly connected to the motor shaft 30, the chain 28 is connected to the driving sprocket 31, and the chain 28 The left end is connected to the protection device 100, the right end of the chain 28 is connected to the cleaning device 101, the motor 49 is started, the active sprocket 31 is driven to rotate by the motor shaft 30, and then simultaneously through the chain 28 Driving the protection device 100 and the cleaning device 101. When the motor shaft 30 to drive the driving pulley 50 rotates, thereby driving said guard device 51 by the drive belt 100.

According to an embodiment, the protection device 100 is described in detail below. The protection device 100 includes a sprocket cavity 19 which is connected to an inner wall of the left side of the chain groove 29 and is open to the left. A left sprocket 48 is rotatably provided in the sprocket cavity 19, and the left end of the chain 28 is connected to the left sprocket 48. A connection shaft 16 is fixedly connected to the left sprocket 48, and the connection shaft 16 The two front and rear ends are rotatably connected to the inner walls of the front and rear sides of the sprocket cavity 19, and the left sprocket 48 is symmetrically and rotatably provided with a connecting gear 15 on the front and rear sides, and the connecting gear 15 is fixedly connected to the connecting shaft. 16. A baffle 14 is slidably provided on the left side of the subgrade 12, and the right end of the baffle 14 abuts the subgrade 12. The baffle 14 can only slide up and down. There are four through-slots 56 that open downward. Small rolling stones can pass through the through-slots 56 to prevent small rolling stones from accumulating on the left side of the roadbed 12. Two teeth are fixed symmetrically on the right end face of the baffle 14. Bar 36, the left ends of the two connecting gears 15 are respectively engaged with the two racks 36, and the driving sprocket 31 rotates through The chain 28 drives the left sprocket 48 to rotate, further drives the connection gear 15 to rotate through the connection shaft 16, and further drives the rack 36 and the baffle 14 to rise.

Beneficially, a groove 25 is provided on the upper inner wall of the chain groove 29 and the opening is upward and leftward. The groove 25 is provided with push plates 21 symmetrically and slidably in the front and back, and the push plates on both sides. A toothed slider 27 is slidably provided between 21, and the toothed slider 27 can be engaged with the push plate 21 on both sides by toothing. The toothed slider 27 is provided with an opening penetrating up and down. A right hinged cavity 26 to the left, a right hinged shaft 23 is rotatably connected between the front and rear inner walls of the right hinged cavity 26, a connecting rod 20 is fixedly connected on the peripheral surface of the right hinged shaft 23, and the left and right sides of the baffle 14 penetrate through A left hinge cavity 18 with an upward opening is provided, and a left hinge shaft 17 is rotatably connected between the front and rear inner walls of the left hinge cavity 18. The left end of the link 20 is fixed to the left hinge shaft 17, and the push plate 21 A threaded hole 55 is provided in the opening facing away from the center of symmetry. The threaded hole 55 is internally screwed with a screw 54. The belt grooves 52 on both sides are located in the inner walls of the groove 25 on the front and rear sides, respectively. An internally driven driven pulley 53 is provided. The upper end of the transmission belt 51 is connected to the driven pulley 53. The screw 54 is far away from the symmetry. One end of the core is respectively fixed to the driven pulley 53. The driving pulley 50 rotates and drives the driven pulley 53 to rotate through the transmission belt 51. Then, the pushers on both sides are driven by the screw 54. The plates 21 slide close to each other, and at the same time, the baffle plate 14 slides up, further drives the connecting rod 20 to swing through the left hinge shaft 17, and further drives the toothed slider 27 to slide through the right hinge shaft 23, and further The toothed slider 27 and the push plate 21 are always maintained in an engaged state. When the toothed slider 27 is engaged with the push plate 21, the toothed slider 27 cannot slide to the left, and further passes through the connecting rod 20 supports the baffle 14. The push plate 21 is provided with a spring groove 24 having an opening facing the center of symmetry. A support plate 22 is slidably provided between the spring grooves 24 on both sides. Springs 58 are fixedly connected between the front and rear ends of the plate 22 and the inner wall of the spring groove 24 away from the center of symmetry.

According to an embodiment, the cleaning device 101 is described in detail below. The cleaning device 101 includes a right sprocket 38 that is rotatably provided on the right side of the active sprocket 31, and a right end of the chain 28 is connected to the right Sprocket 38, a short shaft 37 is fixedly connected to the right sprocket 38, and a driving gear 59 is rotatably provided on the rear side of the right sprocket 38, and the driving gear 59 is fixed to the short shaft 37. A driven gear 60 is engaged with the upper end of the driving gear 59, a vertical shaft 39 is fixedly connected to the upper end of the driven gear 60, and a gear cavity 47 is provided in the upper inner wall of the chain groove 29, and the gear cavity 47 A large gear 41 is rotatably provided therein. The large gear 41 is provided with a gear slot 40 having an opening downward. The upper end of the vertical shaft 39 extends into the gear slot 40 and is fixedly connected with a small gear 45. A transmission gear 46 is engaged with the left end of the pinion 45, and the left end of the transmission gear 46 is engaged with the large gear 41. A slow shaft 43 is fixedly connected to the upper end of the large gear 41, and an upper end of the slow shaft 43 is fixedly connected. A cleaning plate 44 is extended to the outside of the subgrade 12. The driving sprocket 31 rotates and drives the right through the chain 28. The wheel 38 rotates, further drives the driving gear 59 through the short shaft 37, and further drives the driven gear 60, and further rotates the pinion 45 through the vertical shaft 39, thereby driving the transmission The gear 46 rotates, which in turn drives the large gear 41 to rotate, and further drives the cleaning plate 44 to rotate through the slow shaft 43, so that the rolling stones on the roadbed 12 can be concentrated together, and the cleaning plate 44 can rotate 0 to 90°.

According to the embodiment, the buffer device 102 will be described in detail below. The buffer device 102 includes six fixing blocks 32 fixed on the inner wall of the upper side of the cavity 13 and between the two fixing blocks 32 in front and back. A torsion shaft 34 is rotatably connected, and a buffer plate 33 is fixedly connected on the peripheral surface of the torsion shaft 34. A torsion spring 57 is fixedly connected between the front and rear ends of the buffer plate 33 and the fixing blocks 32 on the front and back sides. Under the action of the elastic force of the torsion spring 57, the rolling stone can be buffered by the buffer plate 33.

The following describes the steps of using a landslide protection device in detail in conjunction with FIGS. 1 to 10:

In the initial state, the baffle plate 14 is at the lower limit position, the toothed slider 27 is at the right limit position, and the push plates 21 are at a distance from each other at this time.

When no landslide occurs, the small rolling stones that roll down on the mountain 11 can enter the cavity 13 through the through grooves 56 to prevent the small rolling stones from accumulating on the left side of the roadbed 12.

When a landslide occurs, the motor 49 is started to drive the driving sprocket 31 through the motor shaft 30, and the right sprocket 38 is driven to rotate through the chain 28, and the driving gear 59 is driven to rotate through the short shaft 37, which in turn drives the driven gear 60 Rotate, then drive the pinion 45 through the vertical shaft 39, and then drive the transmission gear 46, and then drive the large gear 41, and then rotate the cleaning plate 44 through the slow shaft 43. As the pinion 45, the transmission gear 46, and the large Gear 41 is a reduction transmission. At this time, the cleaning plate 44 blocks the vehicle on the roadbed 12 to prevent the vehicle from being hit by rolling stones. When the active sprocket 31 rotates, the left sprocket 48 is driven by the chain 28 to rotate, and then through the connecting shaft 16 The connecting gear 15 is driven to rotate, which in turn drives the rack 36 and the baffle 14 to rise, further drives the link 20 to swing through the left hinge shaft 17, and further drives the toothed slider 27 to slide through the right hinge shaft 23. It will be in contact with the support plate 22. The rotation of the motor shaft 30 can simultaneously drive the driving pulley 50 to rotate, and then the driven pulley 53 is driven to rotate by the transmission belt 51, and the pusher is driven by the screw 54. 21 is close to each other, so that the toothed slider 27 is always engaged with the push plate 21, and the support plate 22 is always blocked on the upper side of the toothed slider 27 to prevent the rolling stone from falling and smashing the toothed slider 27. When the baffle 14 rises When the upper limit position is reached, the cleaning plate 44 just rotates to ninety degrees, and the motor 49 is stopped at this time. At this time, the toothed slider 27 cannot slide to the right, and then the baffle 14 is supported by the link 20, and the rolling stone can roll into the cavity. Inside 13, under the elastic force of the torsion spring 57, the rolling stones can be cushioned by the buffer plate 33, and the baffle plate 14 can prevent a large number of rolling stones from falling on the roadbed 12, and at the same time can prevent the roadbed 12 from being damaged by the rolling stones.

When the landslide is over, the motor 49 is reversed to drive the device back to its original state. When the cleaning plate 44 is reversed, the rolling stones on the subgrade 12 can be pushed to both sides to concentrate, and a road can be quickly cleared out. Convenient for rescue vehicles.

The beneficial effect of the present invention is that the present invention is arranged in the roadbed in a region where the frequency of landslides is high. After the landslide occurs, the rolling stones can be dredged and guided, and it can also avoid the traffic congestion caused by the rolling stones and the like falling directly on the road. Slope. The speed of the rolling stones is relatively fast. When the rolling stones are dredged, the rolling speed is slowed down. After the landslide ends, the device is restored to the initial state and the rolling stones falling on the road surface can be automatically cleaned.

In the above manner, those skilled in the art can make various changes according to the working mode within the scope of the present invention.

1. A landslide protection device includes a mountain body and a roadbed;
the roadbed is fixedly arranged at the upper end of the mountain body, and a cavity is formed in the roadbed to penetrate left and right. The rolling stones can be rolled down through the cavity to prevent the rolling stones from falling on the upper end surface of the roadbed to block traffic. A buffer device is provided in the cavity, and since the speed when the rolling stone rolls down is fast, the rolling stone can be buffered by the buffer device;
a driving device is provided in the upper inner wall of the cavity, and a protective device is provided on the left side of the driving device. The protective device can prevent a large number of rolling stones from falling on the roadbed, and a cleaning device is provided on the right side of the driving device. The cleaning device can centrally process the rolling stones on the roadbed;
the protective device, the driving device, and the cleaning device are connected by a chain, and the driving device can simultaneously drive the protective device and the cleaning device, and the protective device and the driving device through the chain. There are two transmission belts connected between them, and the driving device can drive the protective device through the two transmission belts;
a protective plate is fixedly connected to the upper end of the roadbed, and the protective plate is located at the far right of the upper end of the roadbed, and can provide protection for vehicles traveling on the roadbed;
six support pillars are fixedly connected between the inner wall of the upper side of the cavity and the mountain body, and the support pillars can support the roadbed.

2. The landslide protection device according to claim 1, wherein the driving device comprises a belt groove in the inner wall on the upper side of the cavity, which is symmetrically arranged back and forth, and the belt groove is rotatably provided in the belt groove. Driving pulleys, the lower ends of the two transmission belts are respectively connected to the driving pulleys, the upper ends of the transmission belts are connected to the cleaning device, a motor shaft is fixedly connected between the driving pulleys on both sides. A motor is fixed in the front inner wall of the belt groove, and the front end of the motor shaft is dynamically connected to the motor;
a chain groove is provided between the belt grooves on both sides, and an active sprocket is rotatably provided in the chain groove. The active sprocket is fixedly connected to the motor shaft, and the chain is connected to the active chain. The left end of the chain is connected to the protection device, and the right end of the chain is connected to the cleaning device.

3. The landslide protection device according to claim 2, wherein the protection device comprises a sprocket cavity which is connected to an inner wall of the left side of the chain groove, and the sprocket cavity is opened to the left. A left sprocket is rotatably provided in the sprocket cavity. The left end of the chain is connected to the left sprocket. The left sprocket is fixedly connected with a connecting shaft. The inner walls of the front and back sides of the sprocket cavity;
the left sprocket is symmetrically and rotatably provided with a connecting gear, the connecting gear is fixedly connected to the connecting shaft, a baffle is slidably provided on the left side of the subgrade, and the right end of the baffle abuts against The roadbed, the baffle can only slide up and down;
the left and right through the baffle are provided with four through grooves with downward openings, and small rolling stones can pass through the through grooves to prevent small rolling stones from accumulating on the left side of the subgrade;
two racks are symmetrically fixed back and forth in the right end surface of the baffle, and the left ends of the two connecting gears are respectively engaged with the two racks.

4. The landslide protection device according to claim 3, characterized in that: an upper wall and a leftward opening groove are provided in the inner wall of the upper side of the chain groove, and the grooves are symmetrical and slidable in the groove. There is a push plate, and a toothed slider is slidably provided between the push plates on both sides, and the toothed slider can be engaged with the push plates on both sides by toothing;
a right hinge cavity with an opening to the left is provided through the toothed slider up and down, a right hinge shaft is rotatably connected between the front and rear inner walls of the right hinge cavity, and a link is fixed on the peripheral surface of the right hinge shaft. The left and right sides of the baffle plate are provided with a left hinge cavity with an upward opening, a left hinge shaft is rotatably connected between the front and rear inner walls of the left hinge cavity, and the left end of the link is fixedly connected to the left hinge shaft;
the push plate is provided with a threaded hole whose opening faces away from the center of symmetry. The threaded hole is internally connected with a screw. The belt grooves on both sides are respectively located in the inner walls on the front and rear sides of the groove. A driven pulley is provided for rotation, an upper end of the transmission belt is connected to the driven pulley, and an end of the screw far from the symmetrical center is respectively fixed to the driven pulley;
the push plate is provided with a spring groove with an opening facing the center of symmetry, and a support plate is slidably provided between the spring grooves on both sides, and the front and rear ends of the support plate and the inner wall of the spring groove are away from the center of the symmetry. A spring is fixedly connected between them.

5. The landslide protection device according to claim 4, wherein the cleaning device comprises a right sprocket that is rotatably provided on the right side of the active sprocket, and the right end of the chain is connected to the right chain A short shaft is fixedly connected to the right sprocket, and a driving gear is rotatably provided on the rear side of the right sprocket; the driving gear is fixed to the short shaft;
a vertical shaft is fixedly connected to the upper end of the driven gear, and a gear cavity is provided in the inner wall on the upper side of the chain groove. A large gear is rotatably provided in the gear cavity, and a large opening is provided in the large gear. A gear groove, wherein the upper end of the vertical shaft extends into the gear groove and is fixedly connected with a pinion, a transmission gear is provided at the left end of the pinion gear, and the left end of the transmission gear is engaged with the large gear. A slow shaft is fixedly connected to the upper end of the large gear, and the upper end of the slow shaft extends to the outside of the roadbed and a cleaning plate is fixedly connected.

6. The landslide protection device according to claim 5, characterized in that the buffer device comprises six fixed blocks fixed on the inner wall on the upper side of the cavity, and the two fixed blocks rotate forward and backward. A torsion shaft is connected, and a buffer plate is fixedly connected on the circumferential surface of the torsion shaft, and torsion springs are fixedly connected between the front and rear ends of the buffer plate and the fixed blocks on the front and back sides, respectively.
